(19) United States
(12) Patent Application Publication
(10) Pub. No.: US 2026/0212215 A1
(43) Pub. Date: Jul. 23, 2026

(54) CAUSAL DISCOVERY THROUGH KNOWLEDGE GRAPH PREDICTION BY ELIMINATING BACKDOOR PATHS

(71) Applicant: Robert Bosch GmbH, Stuttgart (DE)

(72) Inventors: Cory HENSON, Pittsburgh, PA (US); Utkarshani JAIMINI, West Columbia, SC (US)

(21) Appl. No.: 19/034,169

(22) Filed: Jan. 22, 2025

(51) Int. Cl. G06N 5/022; G06N 5/045

(52) U.S. Cl. CPC G06N 5/022; G06N 5/045

(57) ABSTRACT

A method for causal discovery using knowledge graph link prediction is described. Information from a causal network is translated into a causal knowledge graph, where the graph includes a plurality of causal links. Each causal link comprises a cause entity, a causal relation, an effect entity, and a causal weight that reflects the relative strength of the causal influence of the cause entity on the effect entity. Backdoor paths between cause and effect entities in the causal knowledge graph are identified and removed, producing a backdoor-adjusted causal knowledge graph. This adjusted graph is then converted into embeddings, which are latent vector space representations of the backdoor-adjusted causal knowledge graph. The embeddings are trained using the causal links of the adjusted graph, and subsequently employed for causal discovery, predicting additional causal links in the backdoor-adjusted causal knowledge graph.

### TECHNICAL FIELD

Aspects of the disclosure generally relate to causal link prediction using a knowledge graph.

### BACKGROUND

Causal discovery identifies causal relationships from observational data. Existing approaches using link prediction in knowledge graphs rely on weighted causal relations between cause and effect entities. However, the presence of confounders, which affect both the cause and effect entities, can distort causal predictions and lead to spurious results. This challenge arises because confounders introduce non-causal associations that complicate the accurate identification of true causal links in the data.

### SUMMARY

In one or more illustrative examples, a method for causal discovery using knowledge graph link prediction comprising: translating information from a causal network into a causal knowledge graph, the causal knowledge graph comprising a plurality of causal links, wherein each of the causal links includes a cause entity, a causal relation, an effect entity, and a causal weight indicating a relative strength of causal influence of the cause entity on the effect entity; identifying backdoor paths between cause entities and effect entities in the causal knowledge graph; removing the identified backdoor paths from the causal knowledge graph to create a backdoor-adjusted causal knowledge graph; converting the backdoor-adjusted causal knowledge graph into embeddings, the embeddings comprising a latent vector space representation of the backdoor-adjusted causal knowledge graph; training the embeddings using the causal links of the backdoor-adjusted causal knowledge graph; and using the embeddings for causal discovery to predict additional causal links of the backdoor-adjusted causal knowledge graph.

In one or more illustrative examples, identifying backdoor paths comprises: for a given pair of cause entity and effect entity, identifying a set of nodes that satisfy backdoor path criteria, wherein the backdoor path criteria include: no node in the set is a child of the cause entity; and the set blocks every path between the cause entity and the effect entity containing an incoming edge into the cause entity.

In one or more illustrative examples, removing the identified backdoor paths comprises: removing edges that create the identified backdoor paths between the cause entity and the effect entity.

In one or more illustrative examples, converting the backdoor-adjusted causal knowledge graph into embeddings includes using a graph neural network-based approach, where the causal weights are incorporated into the embedding process.

In one or more illustrative examples, the translating is performed conformant to a causal ontology, the causal ontology defining concepts to structure the causal knowledge graph.

In one or more illustrative examples, the translating further includes: mapping nodes in the causal network into causal entities in the causal knowledge graph; and mapping edges in the causal network into causal links in the causal knowledge graph.

In one or more illustrative examples, performing a Markov-based data split to divide the causal network into training and testing sets before translating the information into the causal knowledge graph.

In one or more illustrative examples, the causal discovery includes causal explanation to predict, given an effect entity, a type of a cause entity.

In one or more illustrative examples, the causal discovery includes causal prediction to predict, given a cause entity, a type of an effect entity.

In one or more illustrative examples, evaluating the performance of the causal discovery using mean reciprocal rank (MRR) and Hits@K metrics.

In one or more illustrative examples, a system for causal discovery using knowledge graph link prediction includes one or more hardware computing devices configured to: translate information from a causal network into a causal knowledge graph, the causal knowledge graph comprising a plurality of causal links, wherein each of the causal links includes a cause entity, a causal relation, an effect entity, and a causal weight indicating a relative strength of causal influence of the cause entity on the effect entity; identify backdoor paths between cause entities and effect entities in the causal knowledge graph; remove the identified backdoor paths from the causal knowledge graph to create a backdoor-adjusted causal knowledge graph; convert the backdoor-adjusted causal knowledge graph into embeddings, the embeddings comprising a latent vector space representation of the backdoor-adjusted causal knowledge graph; train the embeddings using the causal links of the backdoor-adjusted causal knowledge graph; and use the embeddings for causal discovery to predict additional causal links of the backdoor-adjusted causal knowledge graph.

In one or more illustrative examples, to identify backdoor paths comprises: for a given pair of cause entity and effect entity, identifying a set of nodes that satisfy backdoor path criteria, wherein the backdoor path criteria include no node in the set is a child of the cause entity; and the set blocks every path between the cause entity and the effect entity containing an incoming edge into the cause entity.

In one or more illustrative examples, to remove the identified backdoor paths edges that create the identified backdoor paths between the cause entity and the effect entity are removed.

In one or more illustrative examples, to convert the backdoor-adjusted causal knowledge graph into embeddings includes using a graph neural network-based approach, where the causal weights are incorporated into the embedding process.

In one or more illustrative examples, the one or more hardware computing devices are further configured to perform a Markov-based data split to divide the causal network into training and testing sets before translating the information into the causal knowledge graph.

In one or more illustrative examples, the causal discovery includes causal explanation to predict, given an effect entity, a type of a cause entity.

In one or more illustrative examples, the causal discovery includes causal prediction to predict, given a cause entity, a type of an effect entity.

In one or more illustrative examples, the one or more hardware computing devices are further configured to evaluate the performance of the causal discovery using mean reciprocal rank and Hits@K metrics.

In one or more illustrative examples, a non-transitory computer-readable medium includes instructions for causal discovery using knowledge graph link prediction that, when executed by one or more computing devices, cause the one or more computing devices to perform operations including: translate information from a causal network into a causal knowledge graph, the causal knowledge graph comprising a plurality of causal links, wherein each of the causal links includes a cause entity, a causal relation, an effect entity, and a causal weight indicating a relative strength of causal influence of the cause entity on the effect entity; identify backdoor paths between cause entities and effect entities in the causal knowledge graph; remove the identified backdoor paths from the causal knowledge graph to create a backdoor-adjusted causal knowledge graph; convert the backdoor-adjusted causal knowledge graph into embeddings, the embeddings comprising a latent vector space representation of the backdoor-adjusted causal knowledge graph; train the embeddings using the causal links of the backdoor-adjusted causal knowledge graph; and use the embeddings for causal discovery to predict additional causal links of the backdoor-adjusted causal knowledge graph.

In one or more illustrative examples, the causal discovery includes one or more of: causal explanation to predict, given an effect entity, a type of a cause entity; and causal prediction to predict, given a cause entity, a type of an effect entity.

### BRIEF DESCRIPTION OF THE DRAWINGS

FIG. 1 illustrates a causal event graph;

FIG. 2 illustrates a flow diagram of the four phases of disclosed approach to causal discovery with backdoor removal;

FIG. 3 illustrates an example reified relation in the context of a CausalKG;

FIG. 4A illustrates an example CausalKG structure including a subgraph C with causal links with only causal relations;

FIG. 4B illustrates an example CausalKG structure including a subgraph CT with causal links with causal relations and information about entity types;

FIG. 4C illustrates an example CausalKG structure including a subgraph CTP with causal relations, entity type relations, and information about the objects that participate in the causal events;

FIG. 5A is a graph of Causal Explanation: Weighted vs Non-Weighted Relations;

FIG. 5B is a graph of Causal Prediction: Weighted vs Non-Weighted Relations;

FIG. 5C is a graph of MRR Improvement for Causal Explanation with Weights;

FIG. 5D is a graph of MRR Improvement for Causal Prediction with Weights;

FIG. 6 illustrates an example process for causal discovery using knowledge graph;

FIG. 7 depicts a schematic diagram of a control system configured to control a robotic assistant based on the causal discovery; and

FIG. 8 illustrates an example manufacturing system for use in anomaly detection and/or generation of synthetic anomalous data.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Causal discovery traditionally relies on causal Bayesian networks (CBNs), where nodes represent events, and the edges depict the causal relationships between these events. Accurately identifying all causal links within such a network is crucial for numerous downstream tasks. However, practical implementations often encounter incomplete networks due to missing causal links, which can hinder the accurate representation of cause-effect relationships. Recent developments have addressed this challenge by leveraging knowledge graph (KG) structures, where causal networks are encoded as triples, allowing for the use of KG link prediction techniques to discover the missing links. While these methods have successfully identified simple binary causal links, they have limitations when it comes to more complex scenarios, such as mediated or indirect causal pathways.

The present approach advances this domain by incorporating backdoor path adjustment to block confounding influences that can introduce bias into causal predictions. Through the removal of non-causal association flows, this method refines the process of KG-based causal discovery, enabling the detection of more reliable causal links. By adopting a neuro-symbolic framework, it further extends traditional causal discovery techniques, offering a more comprehensive solution for identifying complex causal relationships. This enhanced method has been tested using a causal reasoning benchmark dataset, with results showing improved accuracy and performance compared to prior approaches, particularly in scenarios complicated by backdoor paths.

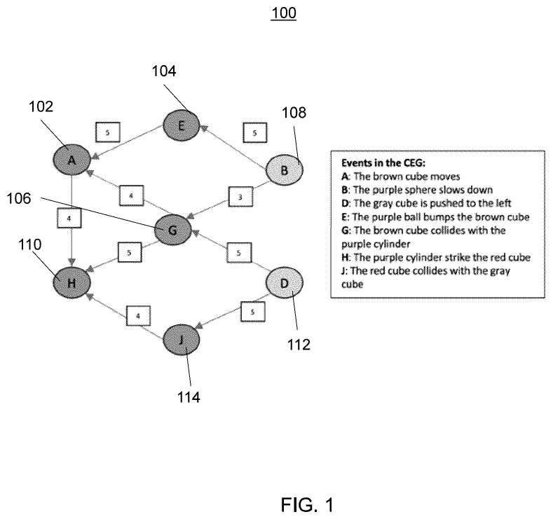

FIG. 1 illustrates a causal event graph (CEG) 100 where the nodes represent distinct events, and the directed edges between the nodes represent causal relationships. The graph includes the following nodes and their corresponding events: A 102 represents the brown cube moving, B 108 represents the purple sphere slowing down, D 112 represents the gray cube being pushed to the left, E 104 represents the purple ball bumping the brown cube, G 106 represents the brown cube colliding with the purple cylinder, H 110 represents the purple cylinder striking the red cube, and J 114 represents the red cube colliding with the gray cube.

The causal relationships in the graph are as follows: A 102 influences E 104 with a weight of 5 and G 106 with a weight of 4. B 108 influences E 104 with a weight of 5 and G 106 with a weight of 3. D 112 influences G 106 with a strength of 5 and J 114 with a weight of 5. E 104 influences B 108 with a weight of 5. G 106 influences H 110 with a weight of 3. H 110 influences J 114 with a weight of 4.

The graph has multiple paths and potential backdoor paths. For example, there's a path from A 102 to H 110 through G 106, and from B 108 to J 114 through E 104, A 102, G 106, and H 110. These complex interconnections pose challenges for causal discovery tasks, especially when using knowledge graph (KG) link prediction methods. The goal of FIG. 1 is to determine the true causal influence of node A 102 on node H 110. The backdoor path from node A 102 to node H 110 through node G 106 may be evaluated by removing the causal edges from A 100 to G 106 and from G 106 to H 110, allowing for an accurate assessment of the direct causal relationship between A 102 and H 110.

The edges between the nodes denote the causal connections, and the numbers on the edges (e.g., 3, 4, 5) represent the strength or weight of the causal influence. For instance, the edge from A 102 to E 104 (event “the purple ball bumps the brown cube”) is labeled with a weight of 4. Similarly, the edge from A 102 to G 106 has a weight of 4, representing the causal influence of A 102 on G 106. The backdoor path from A 102 to H 110 through G 106 is blocked by removing the edges between A 102 and G 106 and between G 106 and H 110, ensuring an unbiased analysis of the causal relationship between A 102 and H 110.

This backdoor path issue is a challenge in causal discovery tasks, especially when using knowledge graph (KG) link prediction methods. The presence of the backdoor path between A 102 and H 110 via G 106 could lead to biased results due to the confounding effect of G 106. By removing these backdoor paths, the causal inference is improved, leading to a more accurate representation of the direct causal influence between A 102 and H 110.

The approach described in FIG. 1 is part of the Back2CausalDisco framework, which enhances causal discovery by eliminating such backdoor paths. This method ensures that common causes, like G 106, are properly accounted for when predicting causal links in a knowledge graph, reducing the bias introduced by spurious correlations in KG link prediction.

The use of knowledge graph link prediction for causal discovery is an early step towards enriching existing neuro-symbolic AI models with causal representation from traditional causal AI. This approach opens the door to using KGs and neuro-symbolic AI methods for causal AI tasks. However, current efforts in causal discovery using KG link prediction do not adequately account for the presence of backdoor paths in a given causal link. A backdoor path represents a common cause influencing both entities in a causal link, leading to inflated evaluation results due to spurious correlations introduced by these paths. FIG. 1 is an example of a backdoor path in a causal network, where node G 106 serves as a common cause for nodes A 102 and H 110.

The Back2CausalDisco framework addresses this issue by removing backdoor paths in the causal discovery process, ensuring that the common cause node G 106 is considered when assessing the causal link between A 102 and H 110. This framework extends the representation of causality within the KG framework, enabling the adoption and use of traditional causal AI concepts. The causal discovery task is formulated as a causal relation prediction task using knowledge graph link prediction. While traditional causal discovery methods derive causal relationships directly from observational data, Back2CausalDisco leverages prior known causal relationships in the causal network to train its link prediction model, aiming to infer new causal relations.

Back2CausalDisco comprises five primary phases: (1) translating known causal relationships into a causal network, (2) removing backdoor paths between the testing and training sets, (3) transforming the causal network into a knowledge graph, (4) learning knowledge graph embedding models for the causal relationships, and (5) predicting new causal links within the knowledge graph. In this approach, the knowledge graph captures causality in the form of a <cause-entity, causes, effect-entity, w> link, where the “causes” relation links the cause and effect entities, and the causal weight, w, represents the strength of the causal influence. A knowledge graph embedding (KGE) model that incorporates weighted relations is used to learn new causal relationships.

The task of causal discovery using KG link prediction is divided into two subtasks: causal prediction and causal explanation. Causal explanation involves finding the type of the head entity (e.g., the cause-entity) in a causal link, while causal prediction involves determining the type of the tail entity (e.g., the effect-entity) in the link. To evaluate causal discovery, the Markov-based data split is employed, which adheres to the Markovian property of the causal network, helping to prevent data leakage and mitigate model bias during the evaluation process.

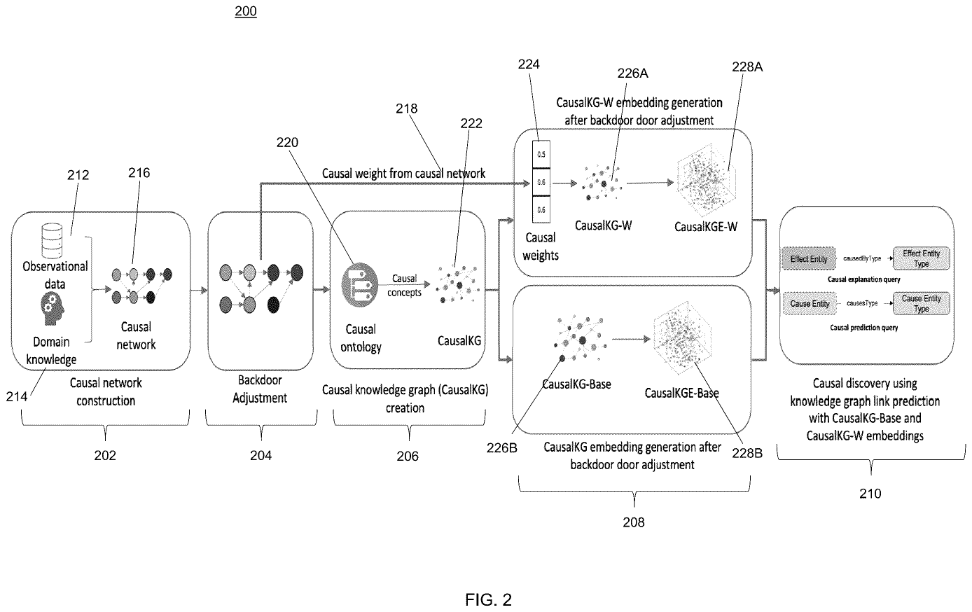

FIG. 2 illustrates a flowchart 200 of a causal discovery process using knowledge graph link prediction. The diagram is divided into several key stages, each representing a crucial step in the causal discovery pipeline.

The process begins with the Causal network construction stage 202. This stage combines domain knowledge 212 and observational data 214 to create a causal network 216. The domain knowledge represents expert insights and established theories, while observational data encompasses empirical evidence collected from the system under study. The causal network is a graphical representation of cause-effect relationships between variables.

The next stage is the Backdoor Adjustment 204, where the initial causal network is refined to address potential backdoor paths. A backdoor path is a non-causal path between a cause-entity (ncause) and its effect-entity (neffect), containing an incoming edge at both the cause and effect entities. These paths can introduce bias in causal inference and must be adjusted to ensure accurate causal discovery.

The Causal knowledge graph (CausalKG) creation stage 206 follows, involving the development of a Causal Ontology 220 and the integration of causal concepts 218 to form the CausalKG 222. The CausalKG is formally defined as a structure (N, R, E, Ec, Wc) where:
N is a set of nodes representing entities
R is a set of labels denoting different types of relations
E⊆N×R×N is a set of edges forming links between pairs of entities
Nc⊆N is a subset of nodes identified as causal entities
Rc⊆R is a subset of labels identified as causal relations
Wc⊆R is a set of real numbers assigning causal weights
Ec⊆Nc×Rc×Nc×Wc is a set of edges connecting pairs of causal entities

The CausalKG then branches into two parallel processes within the CausalKG embedding generation after backdoor adjustment stage 208. The upper branch 226A generates CausalKG-W, incorporating causal weights 224 derived from the causal network, leading to CausalKG-W embeddings 228A. The lower branch 226B generates CausalKG-Base embeddings, resulting in CausalKGE-Base 228B. These embeddings are vector representations of the entities and relations in the knowledge graph, capturing the structural and semantic information of the causal relationships.

The final stage is causal discovery using knowledge graph link prediction 210. This stage utilizes either CausalKG-Base and CausalKG-W embeddings to perform causal discovery tasks. It focuses on two primary forms of causal discovery:

Causal Prediction: determining the type (t) of the effect-entity associated with a given cause-entity (ncause ∈Nc) and the causesType relation (rcausesType ∈Rc). The goal is to find a match such that the quadruple <ncause, rcausesType, t, wc> is a valid link in the CausalKG.

Causal Explanation: identifying the type (t) of the cause-entity associated with a given effect-entity (neffect ∈Nc) and the causedByType relation (rcausedByType ∈Rc). The objective is to establish a connection where the quadruple <neffect, rcausedByType, t, wc> exists in the CausalKG.

The output of causal discovery using knowledge graph link prediction 210 includes Cause Entity and Effect Entity, each associated with their respective Entity Types, representing the discovered causal relationships. These discoveries provide insights into the causal structure of the system, enabling better understanding and prediction of cause-effect dynamics.

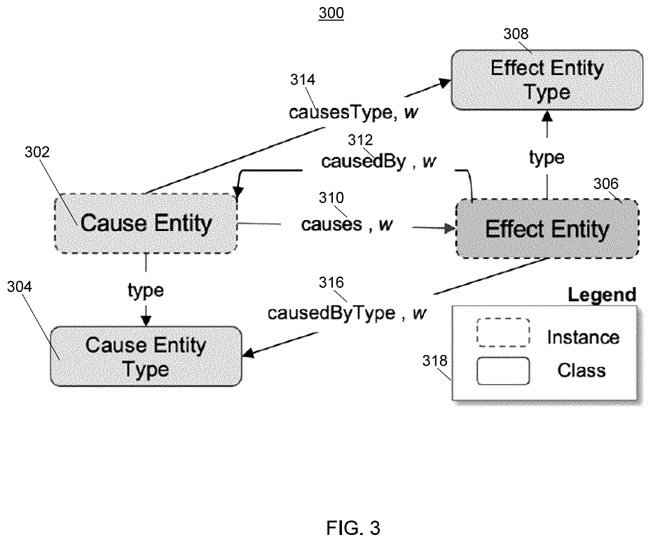

FIG. 3 depicts the schema, or ontology, of a Causal Knowledge Graph 300 (CausalKG) that represents the relationships between cause and effect entities, as well as their respective types, using instances and classes. This graph is structured as a directed acyclic graph (DAG), consistent with a causal Bayesian network, where the nodes represent causal events, and the edges capture the causal links between these events. The network, denoted as CN=(N^{cn},E^{cn},WN^{cn}),, includes nodes N^{cn}, edges \(E^{cn}, and causal weights Wen, representing the strength of causal influences. The direction of each edge indicates the direction of causality, while the weights quantify the impact of changes in one node on another using do-calculus. This structure adheres to the local Markov property, meaning that knowledge of a node's direct causes renders it conditionally independent of unrelated effects.

Cause Entity (Instance) 302 is a specific node representing a particular event or entity responsible for causing another event in the graph. In the context of this CausalKG, Cause Entity (Instance) 302 corresponds to Nₑ^{cn}, representing a cause node in the causal network. For example, if Cause Entity (Instance) 302 were a mechanical failure in a system, it would directly influence an effect, such as downtime or system malfunction. This instance is essential for understanding the specific chain of causality within the model.

Cause Entity Type 304 represents the generalized type of the Cause Entity (Instance) 302. This corresponds to a class of causes rather than individual instances, providing an abstraction that allows for more generalized reasoning across similar entities. In this case, Cause Entity Type 304 could represent all types of mechanical failures, encompassing individual failures represented by Cause Entity (Instance) 302. This generalization enables the system to infer causal relationships on a broader scale, rather than being restricted to a single instance.

Effect Entity (Instance) 306 is the specific event or entity that results from the causal influence of Cause Entity (Instance) 302. This node corresponds to Nen, the effect node in the causal network, indicating a direct outcome of the causal relationship. For example, if Cause Entity (Instance) 302 represents a failure, Effect Entity (Instance) 306 could represent the operational failure or downtime caused by that failure. Understanding this instance-level effect is crucial for the system to model direct causal influences and explain specific outcomes.

Effect Entity Type 308 is the generalized class of outcomes or effects to which the Effect Entity (Instance) 306 belongs. Similar to the cause type, Effect Entity Type 308 abstracts the effect entity into a category of outcomes. For instance, this type could represent all system downtimes or operational malfunctions, rather than just the specific instance depicted by Effect Entity (Instance) 306. This generalization allows the system to reason over broader patterns of causality, where different causes lead to similar classes of effects.

Causes, w (Causal Link) 310 represents the directed edge from Cause Entity (Instance) 302 to Effect Entity (Instance) 306, symbolizing the causal relationship between the two. This edge corresponds to E^{cn} in the causal network, with the label “causes, w” indicating that Cause Entity (Instance) 302 is responsible for causing Effect Entity (Instance) 306, and w representing the causal weight W^{cn}. The weight w quantifies the strength of the causal influence, which could be interpreted probabilistically or as a measure of impact. For instance, the weight w might indicate the likelihood or magnitude of the effect caused by the failure event.

CausedBy, w (Inverse Causal Link) 312 is the reverse edge from Effect Entity (Instance) 306 back to Cause Entity (Instance) 302, representing the inverse causal relationship. This edge corresponds to the inverse of E^{cn}, showing that Effect Entity (Instance) 306 can be traced back to Cause Entity (Instance) 302 as its origin. The causal weight w associated with this link measures the strength of this inverse relationship. In a practical context, if the system observes an effect (such as downtime), it can use the inverse causal link to infer the most likely cause (such as a specific mechanical failure).

CausesType, w (Causal Type Link) 314 connects Cause Entity (Instance) 302 to Effect Entity Type 308, representing a generalized causal relationship between the specific cause instance and the broader class of effect types. This reified relation allows the system to infer that specific cause entities (such as Cause Entity (Instance) 302) typically lead to a general category of effects (such as Effect Entity Type 308). The causal weight w associated with this edge quantifies the strength of this general relationship, providing a measure of how likely a specific cause is to lead to a broad category of effects.

CausedByType, w (Inverse Causal Type Link) 316 is the inverse relation between Effect Entity (Instance) 306 and Cause Entity Type 304, indicating that a specific effect instance can be attributed to a general class of causes. This relation is particularly useful for inferring that a specific observed effect (such as Effect Entity (Instance) 306) may have been caused by any member of a broader cause category (such as Cause Entity Type 304). The causal weight w again measures the strength of this inverse relationship, allowing the system to quantify the likelihood of a generalized cause leading to a specific effect.

The legend 318 provided in FIG. 3 distinguishes between instances and types within the CausalKG. Instances, represented by dashed lines around their corresponding nodes, are specific entities or events, while types, represented by solid lines, are generalized categories. This visual distinction is essential for understanding how the system handles both specific and abstract causal reasoning. The system can perform fine-grained causal discovery by reasoning about specific instances, while also making more generalized predictions and explanations by reasoning over types.

The graph 300 facilitates both causal discovery and explanation by modeling the relationships between causes and effects at both the instance and type levels. The causal weights W^{cn} assigned to the edges allow for quantitative reasoning about the strength of these relationships, making the system well-suited for tasks such as link prediction, entity classification, and causal explanation. The CausalKG enriches causal networks by adding reified causal links, such as causesType and causedByType, enabling the system to perform causal discovery using techniques such as link prediction, while also adhering to a causal ontology that ensures semantic consistency across different causal relations.

In a causal network, a Backdoor Path (BD) represents a non-causal path between a pair of nodes N_{cn}^{c} and N_{cn}^{e}, where N_{cn}^{c} is the cause and N_{cn}^{e} is the effect. The purpose of identifying backdoor paths is to account for common causes that may introduce bias in estimating the direct causal relationship between the cause and effect. In FIG. 3, this concept is represented by potential paths that exist outside of the direct causes, w 310 and causedBy, w 312 relationships between Cause Entity (Instance) 302 and Effect Entity (Instance) 306.

A backdoor path exists when the influence from the Cause Entity (Instance) 302 to the Effect Entity (Instance) 306 is mediated by one or more common ancestors (nodes that cause both the cause and the effect). These non-causal paths can distort the true causal effect of Cause Entity (Instance) 302 on Effect Entity (Instance) 306, potentially leading to inflated results if not addressed. In the context of causal inference, this bias is often referred to as confounding, and methods like do-calculus are used to control for these backdoor paths.

To accurately estimate the true causal influence of N_{cn}^{c} (corresponding to Cause Entity (Instance) 302) on N_{cn}^{e} (corresponding to Effect Entity (Instance) 306), it is essential to block all backdoor paths. A backdoor path is blocked if the set of nodes BDᵢ satisfies the following conditions: (1) no node in the set is a child of the Cause Entity (Instance) 302; and (2) every path between Cause Entity (Instance) 302 and Effect Entity (Instance) 306 that includes an incoming edge into Cause Entity (Instance) 302 is intercepted by a node in BDᵢ.

The process of blocking backdoor paths ensures that only the direct causal relationship between the cause and effect is considered, removing the influence of spurious or non-causal connections. In practical terms, the system uses this method to refine its causal predictions, ensuring that the relationship between Cause Entity (Instance) 302 and Effect Entity (Instance) 306 reflects true causality and not indirect associations.

Two sets of backdoor paths are typically considered in causal networks: Sufficient BD paths and Maximum BD paths. The Sufficient BD path is the minimal set of nodes required to block all backdoor paths between a cause and an effect. In the context of FIG. 3, this could represent the minimum number of connections necessary to isolate the true causal relationship between Cause Entity (Instance) 302 and Effect Entity (Instance) 306, ensuring that only direct influences are considered. On the other hand, the Maximum BD path includes all possible backdoor paths that need to be blocked for a given pair of cause and effect entities. This comprehensive set covers every possible non-causal influence, allowing for a more exhaustive approach to removing bias.

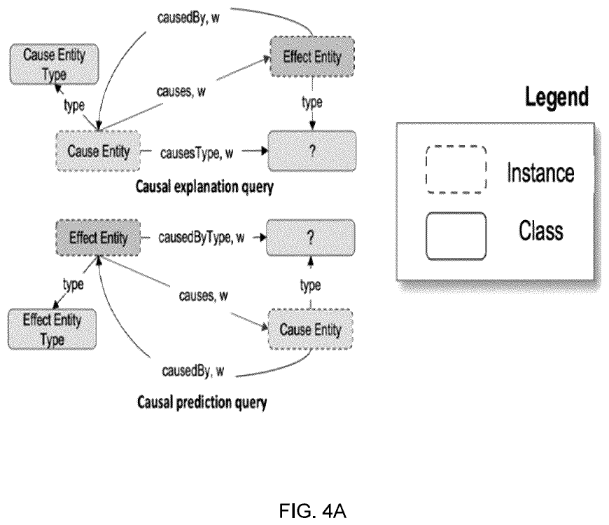

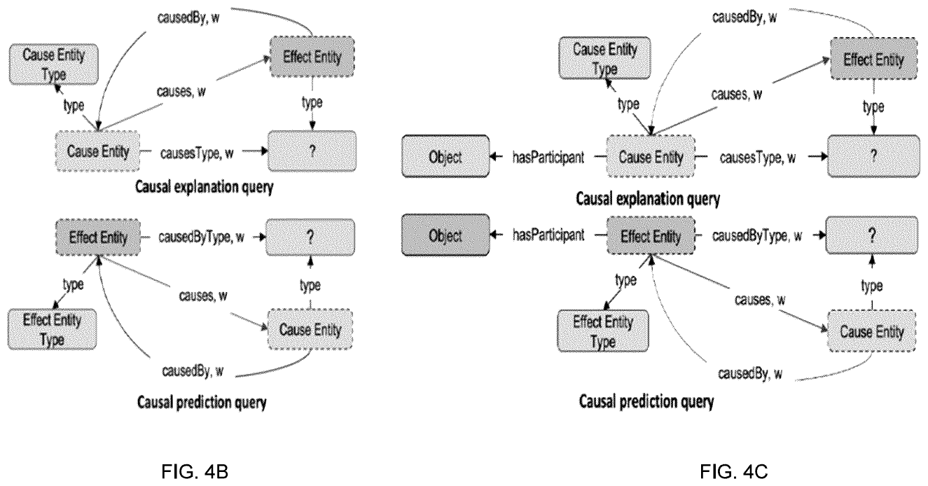

FIGS. 4A-C depict different structures of Causal Knowledge Graphs (CausalKGs) derived from the CLEVRER-Humans dataset, which are used to evaluate causal explanation and causal prediction tasks through knowledge graph embedding (KGE) models. These tasks are essential for assessing how well the system can infer types of cause entities from observed effect entities and vice versa, based on the causal relationships captured in the knowledge graph.

FIG. 4A shows a subgraph (C) of the CausalKG, which consists exclusively of causal relations. The causal relationships include causes, w and causedBy, w, which denote the direction of causality between a Cause Entity (Instance) and an Effect Entity (Instance), and reified relations such as causesType, w and causedByType, w, which establish the connection between entity instances and their types. In this subgraph, the task of causal explanation is represented by the query format <n_{effect}, r_{causedByType},?, w>, where the system attempts to predict the type of a cause entity given an effect entity. The causal prediction query is formatted as <n_{cause}, r_{causesType},?, w>, where the system forecasts the type of an effect entity based on a given cause entity. These queries focus on understanding direct causal links between instances of causes and effects without considering additional information about the entities involved.

FIG. 4B extends the graph from FIG. 4A by including entity type information, referred to as subgraph (CT). In addition to the causal relations captured in FIG. 4A, this subgraph introduces relations like rdf:type, which links each Cause Entity (Instance) to its corresponding Cause Entity Type and each Effect Entity (Instance) to its corresponding Effect Entity Type. This expanded graph structure allows for more refined reasoning during the causal explanation and causal prediction tasks by including type-level information. As seen in FIG. 4B, the system is now capable of leveraging both instance-level and type-level data when making predictions, which can improve the accuracy of the system's causal inferences by understanding how different types of entities interact causally.

FIG. 4C introduces a further extension, shown as subgraph (CTP), which incorporates additional information about the objects involved in the causal events. In this structure, the system not only considers causal relationships and entity types but also integrates object-level data using the relation hasParticipant, which connects both the Cause Entity (Instance) and the Effect Entity (Instance) to the objects that participated in the events. These objects are characterized by properties such as color, shape, and material, as extracted from the CLEVRER-Humans dataset. By including object participation data, this graph enhances the system's ability to perform causal reasoning by considering the physical attributes and roles of objects in the events. This rich representation enables a more holistic understanding of the causality behind the events, allowing for finer-grained predictions and explanations. For instance, in addition to identifying the cause and effect types, the system can determine which specific objects were involved in the causal interaction.

Each of these subgraphs (C, CT, and CTP) presents progressively more detailed representations of the causal knowledge extracted from the CLEVRER-Humans dataset. By evaluating the system's performance on each of these variations, the study assesses how additional information-ranging from basic causal links to more detailed data about entity types and object participation-affects the system's ability to accurately perform causal explanation and prediction tasks.

The CausalKGE-Base and CausalKGE-W embeddings were developed and tested across various subgraph structures within the CLEVRER-Humans CausalKG to assess their effectiveness in causal explanation and prediction tasks. These subgraphs varied in complexity and detail, as illustrated in FIG. 4. Specifically, three different subgraph structures were evaluated, increasing in expressivity: Graph Structure C, which includes only basic links with causal relations; Graph Structure CT, which encompasses causal relations and types of causal entities, adding a layer of semantic detail; and Graph Structure CTP, the most detailed structure, incorporating causal relations, entity types, and relationships to objects involved in causal events.

For each graph structure, hyper-parameters were carefully optimized to enhance the performance of the corresponding tasks-causal explanation and prediction. The optimized CausalKGE models were then applied to causal discovery, utilizing established link prediction techniques to evaluate their performance effectively.

The evaluation of Back2CausalDisco was performed by following the KG link prediction experiment design. For a given set of causal links E_{c} in CausalKG, a set of corrupted links T′ were generated by replacing the head hc or tail tc of a set of causal links [symbol] hc,rc,tc,wc [symbol] with another causal entity in the KG. Replacing the head with h′≠hc results in [symbol] h′,rc,tc,wc [symbol] or replacing the tail with t′≠tc results in [symbol] hc,rc,t′,wc [symbol] . The model scores the true link [symbol] hc,rc,tc,wc [symbol] and the corrupted links [symbol] h′,rc,tc,wc [symbol] , [symbol] hc,rc,t′, wc [symbol] ∈T′. The scores are then sorted to obtain the rank of the true link. The filtered evaluation setting and filtered corrupted links T′ are used to exclude the links present in the training and validation set. The overall performance of the models is measured using mean reciprocal rank (MRR) and Hits@K for k={1,3,10}. MRR is the mean over the reciprocal of individual ranks of test links, and Hits@k is the ratio of test links present among the top k ranked links.

TABLE 1
Causal prediction without weights

| | | MRR | MRR w/o | MRR w/o |
|---|---|---|---|---|
| Algorithm | Subgraph | w/BD | BDMax | Sufficient |
| TransE | C | 0.43 | 0.1864 | 0.1864 |
| TransE | CT | 0.23 | 0.1859 | 0.1833 |
| TransE | CTP | 0.30 | 0.2495 | 0.2384 |
| TransE | Average | 0.319 | 0.207 | 0.203 |
| DistMult | C | 0.33 | 0.245 | 0.1171 |
| DistMult | CT | 0.22 | 0.1667 | 0.1658 |
| DistMult | CTP | 0.18 | 0.2301 | 0.1092 |
| DistMult | Average | 0.243 | 0.214 | 0.131 |
| HoLE | C | 0.28 | 0.1649 | 0.0978 |
| HoLE | CT | 0.18 | 0.1573 | 0.0651 |
| HoLE | CTP | 0.20 | 0.1279 | 0.0568 |
| HoLE | Average | 0.220 | 0.150 | 0.073 |
| ComplEx | C | 0.32 | 0.1094 | 0.0663 |
| ComplEx | CT | 0.13 | 0.1201 | 0.015 |
| ComplEx | CTP | 0.12 | 0.2726 | 0.2726 |
| ComplEx | Average | 0.188 | 0.167 | 0.118 |

In the experiments without weights, the performance of the algorithms across the different subgraphs varied. TransE achieved an MRR of 0.43 for subgraph C, 0.23 for subgraph CT, and 0.30 for subgraph CTP. The averages across all subgraphs for TransE were 0.319 with backdoor paths, 0.207 without the maximum backdoor paths, and 0.203 without the sufficient backdoor paths. Similarly, DistMult scored an MRR of 0.33 for subgraph C, 0.22 for CT, and 0.18 for CTP, with averages of 0.243, 0.214, and 0.131, respectively. HoLE achieved MRRs of 0.28, 0.18, and 0.20 across subgraphs C, CT, and CTP, with averages of 0.220 with backdoor paths, 0.150 without maximum backdoor paths, and 0.073 without sufficient backdoor paths. ComplEx scored 0.32, 0.13, and 0.12 for subgraphs C, CT, and CTP, respectively, averaging 0.188 with backdoor paths, 0.167 without maximum backdoor paths, and 0.118 without sufficient backdoor paths.

TABLE 2
Causal prediction with weights

| | | MRR | MRR w/o | MRR w/o |
|---|---|---|---|---|
| Algorithm | Subgraph | w/BD | BDMax | Sufficient |
| TransE | C | 0.85 | 0.5307 | 0.5307 |
| TransE | CT | 0.71 | 0.4143 | 0.3796 |
| TransE | CTP | 0.80 | 0.6006 | 0.5315 |
| TransE | Average | 0.787 | 0.515 | 0.481 |
| DistMult | C | 0.37 | 0.3457 | 0.338 |
| DistMult | CT | 0.44 | 0.3058 | 0.3897 |
| DistMult | CTP | 0.48 | 0.2877 | 0.272 |
| DistMult | Average | 0.430 | 0.313 | 0.333 |
| HoLE | C | 0.36 | 0.3121 | 0.2397 |
| HoLE | CT | 0.60 | 0.3029 | 0.2605 |
| HoLE | CTP | 0.51 | 0.3145 | 0.2689 |
| HoLE | Average | 0.490 | 0.310 | 0.256 |
| ComplEx | C | 0.37 | 0.3497 | 0.2277 |
| ComplEx | CT | 0.36 | 0.3287 | 0.1938 |
| ComplEx | CTP | 0.32 | 0.3245 | 0.3245 |
| ComplEx | Average | 0.350 | 0.334 | 0.249 |

In the experiments with weights, TransE showed improved performance with an MRR of 0.85 for subgraph C, 0.71 for CT, and 0.80 for CTP. The average MRRs for TransE were 0.787 with backdoor paths, 0.515 without maximum backdoor paths, and 0.481 without sufficient backdoor paths. DistMult scored lower, with MRRs of 0.37 for subgraph C, 0.44 for CT, and 0.48 for CTP, and averages of 0.430, 0.313, and 0.333. HoLE's performance varied, with MRRs of 0.36, 0.60, and 0.51 for subgraphs C, CT, and CTP, respectively, and averages of 0.490 with backdoor paths, 0.310 without maximum backdoor paths, and 0.256 without sufficient backdoor paths. ComplEx had MRRs of 0.37 for subgraph C, 0.36 for CT, and 0.32 for CTP, averaging 0.350 with backdoor paths, 0.334 without maximum backdoor paths, and 0.249 without sufficient backdoor paths.

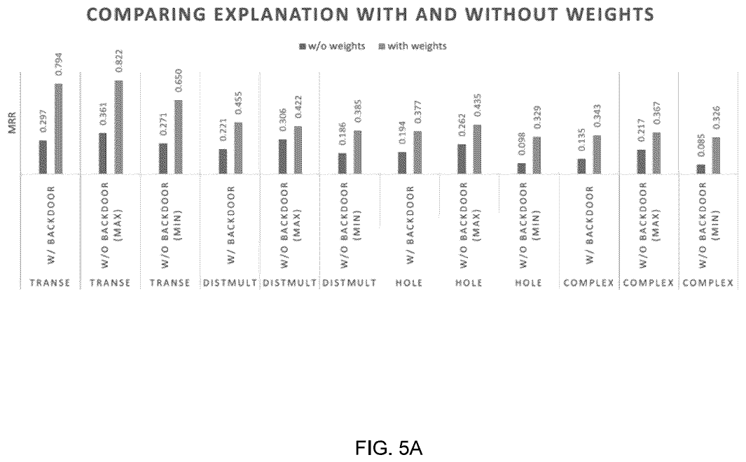

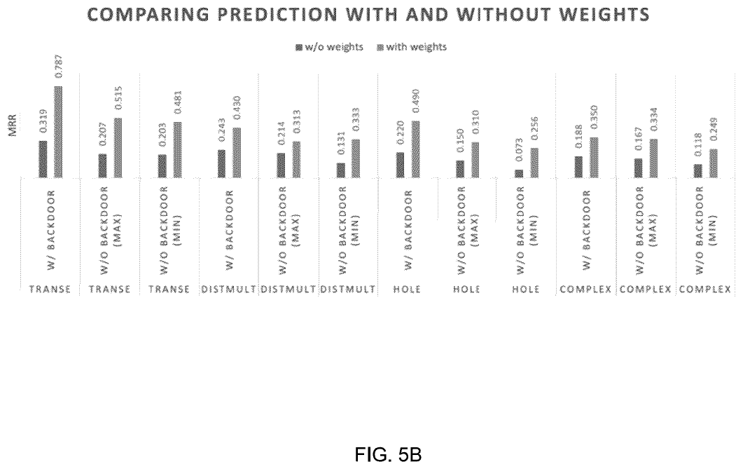

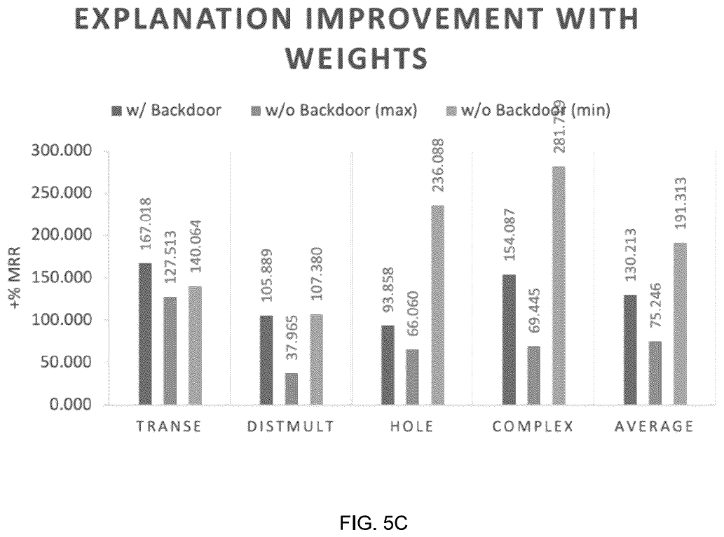

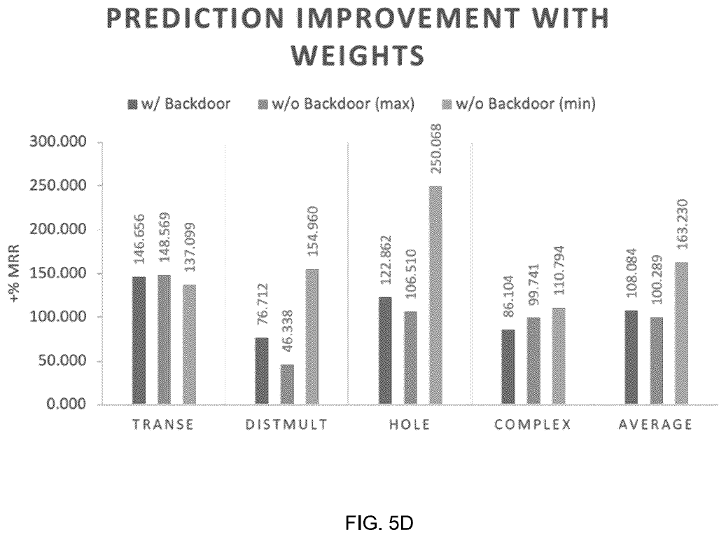

The results shown in FIGS. 5A and 5B highlight the performance of causal explanation and causal prediction tasks with and without weighted causal relations, providing a detailed comparison across different knowledge graph embedding (KGE) models. Specifically, the results emphasize the differences in mean reciprocal rank (MRR) scores when backdoor paths are present, absent, or adjusted for, as these paths can introduce confounding bias.

In FIG. 5A, which focuses on causal explanation, we see significant improvements in performance when using weighted causal relations across all KGE models. The MRR scores for causal explanation increase when weighted causal relations are considered, demonstrating that the incorporation of weights leads to more accurate causal discovery. For instance, the CausalK GE-W model, which includes weighted causal relations, consistently outperforms the base model without weights (CausalKGE-Base). TransE, DistMult, HoLE, and ComplEx all show improved MRRs in the weighted setting, particularly when backdoor paths are accounted for. The CausalKGE-W-MaximumBackdoor configuration exhibits a higher MRR compared to CausalKGE-Base-SufficientBackdoor by 38.85%, illustrating the importance of addressing backdoor paths effectively.

FIG. 5B, which addresses causal prediction, follows a similar trend. Again, models that incorporate weighted causal relations outperform their non-weighted counterparts. The MRR scores in the CausalKGE-W configurations, especially when maximum and sufficient backdoor paths are considered, show consistent improvements in predictive performance. For example, the CausalKGE-W-MaximumBackdoor model improves causal prediction MRRs by 22.46% over the CausalKGE-Base-SufficientBackdoor.

FIGS. 5C and 5D illustrate the percentage improvement in MRR for causal explanation and causal prediction, respectively, when using weighted causal relations. The MRR scores for causal explanation with the CausalKGE-W-MaximumBackdoor configuration outperform the CausalKGE-Base configuration by 4.72%, with the MaximumBackdoor and SufficientBackdoor setups showing significant gains as well. In particular, weighted causal relations appear to mitigate the confounding bias introduced by backdoor paths, resulting in improved causal discovery accuracy.

The MRR scores for causal prediction, as shown in FIG. 5D, reveal that models using backdoor path adjustments with weighted causal relations perform significantly better than those without such adjustments. The CausalKGE-W model with backdoor path configurations consistently outperforms the base model, and the percentage improvements are highest when both maximum and sufficient backdoor paths are considered.

Across all the evaluated KGE models and subgraph structures, the use of weighted causal relations consistently leads to better performance. Both causal explanation and prediction tasks benefit from adjustments that account for backdoor paths, demonstrating that addressing confounding bias in causal discovery tasks is crucial. The MRR improvements highlight the effectiveness of these techniques, particularly in the CausalKGE-W models, which leverage weighted causal relations to achieve more accurate predictions.

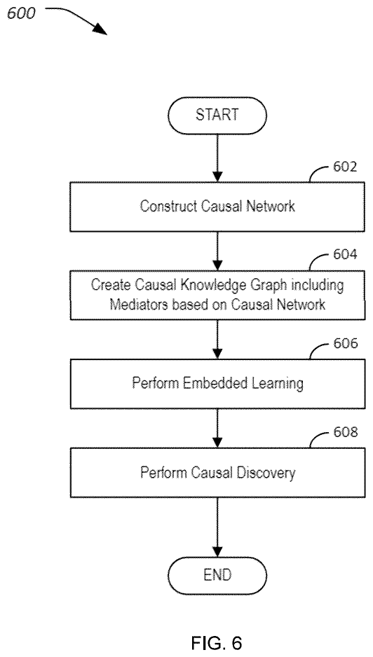

FIG. 6 illustrates an example process 600 for causal discovery without backdoors. The process 600 may be implement the disclosed approach to causal discovery using knowledge graph link prediction addresses a crucial gap in the state-of-the-art by considering mediator information along with a causal links. Using the process 600, the results demonstrate that knowledge incorporated in the hyper-relations significantly improves the causal link 308 prediction.

At operation 602, causal network construction is performed. The causal network construction may include finding and encoding the known causal relations into a causal network. This causal network construction may be performed using observational data and/or using domain knowledge.

At operation 604, causal knowledge graph creation 604 is performed. The causal knowledge graph creation 604 may include translating the causal network 610 into a CausalKG 616, conformant to a causal ontology 618. The CausalKG 616 may include a plurality of causal links, each of the causal links includes a cause entity, a causal relation, an effect entity, and a causal weight indicating a relative strength of causal influence of the cause entity on the effect entity. In an example, information from the causal network may be translated into CausalKG according to a mapping. The mapping may include mapping nodes in the causal network into causal entities in the CausalKG and mapping edges in the causal network into causal links in the CausalKG.

At operation 606, embedding learning is performed. The embedding learning may include learning KG embedding models for the CausalKG using the train set, and evaluating the training using the test set. This may be performed in two different approaches. In a first approach, CausalKGE-Base is generated using embedding without mediators (no hyper-relations). The CausalKGE-Base embedding may be trained using the causal links, ignoring the mediators associated with each link. In a second approach the CausalKGE-M is generated using embeddings with mediators as hyper-relations (represented using qualifier pairs). The CausalKGE-M embedding may be trained using the causal links 308 with the mediators. The CausalKGE-Base and CausalKGE-M embeddings may be evaluated on the task of causal link prediction using KG link prediction techniques. The CausalKG 216 embeddings for CausalKGE-Base may be generated using KG embedding algorithms available in the Ampligraph library2, in an example. The CausalKGE-M may be generated as a graph neural network based, hyper-relational KGE 224 model, such as StarE. In many examples, the application of the qualifier pairs from the causal network outperforms baseline KGE metrics without being trained on the hyper-relations.

At operation 608, causal discovery is performed. The causal discovery may include using the knowledge graph embeddings for causal discovery tasks. One example of such a task is predicting new causal links 308 in the CausalKG. In some examples, the causal discovery includes casual explanation to predict, given an effect entity, a type of a cause entity of the additional causal link. In some examples, the causal discovery includes casual prediction to predict, given a cause entity, a type of an effect entity of the additional causal link. After operation 608, the process 600 ends.

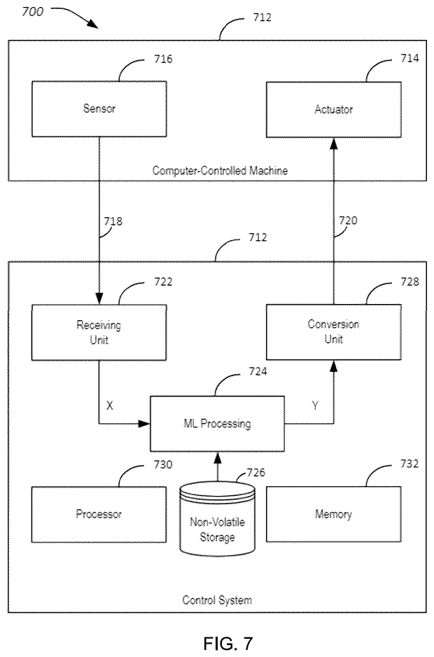

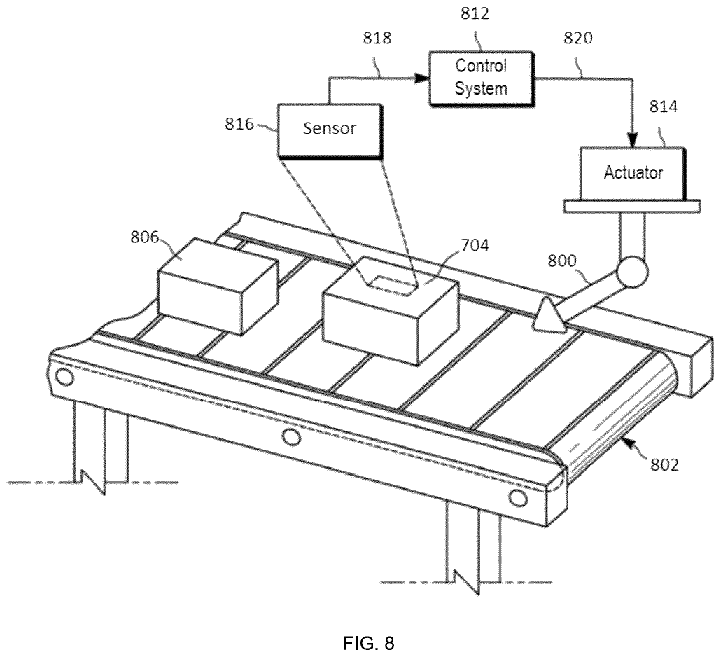

FIG. 7 depicts a schematic diagram of an interaction between a computer-controlled machine 702 and a control system 712. The computer-controlled machine 702 may implement aspects of the causal discovery 208 and use of the predicted causal information. Referring to FIG. 6, and with reference to FIGS. 1-4B, the approaches discussed herein may be performed in the context of such a computer-controlled machine 702 and control system 712. The computer-controlled machine 702 includes actuator 714 and sensor 716. Actuator 714 may include one or more actuators and sensor 716 may include one or more sensors. Sensor 716 is configured to sense a condition of computer-controlled machine 702. Sensor 716 may be configured to encode the sensed condition into sensor signals 718 and to transmit sensor signals 718 to control system 712. Non-limiting examples of sensor 716 include video, radar, LiDAR, ultrasonic and motion sensors. In one embodiment, sensor 716 is an optical sensor configured to sense optical images of an environment proximate to computer-controlled machine 1102.

Control system 712 is configured to receive sensor signals 718 from computer-controlled machine 702. As set forth below, control system 718 may be further configured to compute actuator control commands 720 depending on the sensor signals 1118 and to transmit actuator control commands 720 to actuator 714 of computer-controlled machine 702.

As shown in FIG. 6, control system 712 includes receiving unit 722. Receiving unit 722 may be configured to receive sensor signals 718 from sensor 716 and to transform sensor signals 1118 into input signals X. In an alternative embodiment, sensor signals 718 are received directly as input signals X without receiving unit 722. Each input signal x may be a portion of each sensor signal 718. Receiving unit 722 may be configured to process each sensor signal 718 to product each input signal x. Input signal x may include data corresponding to an image recorded by sensor 716.

Control system 712 includes machine learning (ML) processing 724. ML processing 724 may be configured to learn, classify, infer, generate, etc. using one or more models such as those described in detail above. In an example, ML processing 724 is configured to determine output signals Y from input signals X. Each output signal y includes information that assigns one or more labels to each input signal X. ML processing 724 may transmit output signals Y to conversion unit 728. Conversion unit 728 is configured to convert output signals Y into actuator control commands 720. Control system 712 is configured to transmit actuator control commands 720 to actuator 714, which is configured to actuate computer-controlled machine 702 in response to actuator control commands 720. In another embodiment, actuator 714 is configured to actuate computer-controlled machine 702 based directly on output signals Y.

Upon receipt of actuator control commands 720 by actuator 714, actuator 714 is configured to execute an action corresponding to the related actuator control command 720. Actuator 714 may include a control logic configured to transform actuator control commands 720 into a second actuator control command 720, which is utilized to control actuator 714. In one or more embodiments, actuator control commands 720 may be utilized to control a display instead of or in addition to an actuator 714.

In another embodiment, control system 712 includes sensor 716 instead of or in addition to computer-controlled machine 702 including sensor 716. Control system 712 may also include actuator 714 instead of or in addition to computer-controlled machine 702 including actuator 714.

As shown in FIG. 9, control system 712 also includes processor 730 and memory 732. Processor 730 may include one or more processors. Memory 732 may include one or more memory devices. The causal hyper-relation links determined by one or more embodiments may be implemented by control system 712, which includes non-volatile storage 726, processor 730 and memory 732.

Non-volatile storage 726 may include one or more persistent data storage devices such as a hard drive, optical drive, tape drive, non-volatile solid-state device, cloud storage or any other device capable of persistently storing information. Processor 730 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 732. Memory 732 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 730 may be configured to read into memory 732 and execute computer-executable instructions residing in non-volatile storage 726 and embodying one or more ML algorithms and/or methodologies of one or more embodiments. Non-volatile storage 726 may include one or more operating systems and applications. Non-volatile storage 726 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 730, the computer-executable instructions of non-volatile storage 726 may cause control system 712 to implement one or more of the ML algorithms and/or methodologies as disclosed herein. Non-volatile storage 726 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 8 illustrates an example manufacturing system 800 for use in anomaly detection and/or generation of synthetic anomalous data. The system 800 may be configured to control a manufacturing machine 802, such as a punch cutter, a cutter or a gun drill, etc., such as part of a production line.

The system 800 may be configured to control an actuator 814, which is configured to control the manufacturing machine 802. A sensor 716 of the system 800 may be configured to capture one or more properties of a manufactured product 804. ML processing 724 may be configured to determine a state of the manufactured product 804 from one or more of the captured properties. An actuator 714 may be configured to control the system 800 (e.g., a manufacturing machine) depending on the determined state of the manufactured product 804 for a subsequent manufacturing step of the manufactured product 804. In particular, the actuator 714 may be configured to control functions of system 800 (e.g., the manufacturing machine) on subsequent manufactured product 806 of the system 800 (e.g., the manufacturing machine) depending on the determined state of the manufactured product 804.

For example, the system 800 may utilize CausalKG to predict reasons for issues in the manufacturing system 800, such as what issue was causedBy. Or, the system 800 may utilize CausalKG to predict outcomes that should be addressed, such as that sensed input may cause an issue, e.g., causesType.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as ASICs, FPGAs, state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for causal discovery using knowledge graph link prediction comprising:
translating information from a causal network into a causal knowledge graph, the causal knowledge graph comprising a plurality of causal links, wherein each of the causal links includes a cause entity, a causal relation, an effect entity, and a causal weight indicating a relative strength of causal influence of the cause entity on the effect entity;
identifying backdoor paths between cause entities and effect entities in the causal knowledge graph;
removing the identified backdoor paths from the causal knowledge graph to create a backdoor-adjusted causal knowledge graph;
converting the backdoor-adjusted causal knowledge graph into embeddings, the embeddings comprising a latent vector space representation of the backdoor-adjusted causal knowledge graph;
training the embeddings using the causal links of the backdoor-adjusted causal knowledge graph; and
using the embeddings for causal discovery to predict additional causal links of the backdoor-adjusted causal knowledge graph.

2. The method of claim 1, wherein identifying backdoor paths comprises:
for a given pair of cause entity and effect entity, identifying a set of nodes that satisfy backdoor path criteria, wherein the backdoor path criteria include: no node in the set is a child of the cause entity; and
the set blocks every path between the cause entity and the effect entity containing an incoming edge into the cause entity.

3. The method of claim 2, wherein removing the identified backdoor paths comprises: removing edges that create the identified backdoor paths between the cause entity and the effect entity.

4. The method of claim 1, wherein converting the backdoor-adjusted causal knowledge graph into embeddings includes using a graph neural network-based approach, where the causal weights are incorporated into the embedding process.

5. The method of claim 1, wherein the translating is performed conformant to a causal ontology, the causal ontology defining concepts to structure the causal knowledge graph.

6. The method of claim 1, wherein the translating further includes: mapping nodes in the causal network into causal entities in the causal knowledge graph; and mapping edges in the causal network into causal links in the causal knowledge graph.

7. The method of claim 1, further comprising: performing a Markov-based data split to divide the causal network into training and testing sets before translating the information into the causal knowledge graph.

8. The method of claim 1, wherein the causal discovery includes causal explanation to predict, given an effect entity, a type of a cause entity of the additional causal link.

9. The method of claim 1, wherein the causal discovery includes causal prediction to predict, given a cause entity, a type of an effect entity of the additional causal link.

10. The method of claim 1, further comprising: evaluating the performance of the causal discovery using mean reciprocal rank and Hits@K metrics.

11. A system for causal discovery using knowledge graph link prediction, comprising: one or more hardware computing devices configured to:
translate information from a causal network into a causal knowledge graph, the causal knowledge graph comprising a plurality of causal links, wherein each of the causal links includes a cause entity, a causal relation, an effect entity, and a causal weight indicating a relative strength of causal influence of the cause entity on the effect entity;
identify backdoor paths between cause entities and effect entities in the causal knowledge graph;
remove the identified backdoor paths from the causal knowledge graph to create a backdoor-adjusted causal knowledge graph;
convert the backdoor-adjusted causal knowledge graph into embeddings, the embeddings comprising a latent vector space representation of the backdoor-adjusted causal knowledge graph;
train the embeddings using the causal links of the backdoor-adjusted causal knowledge graph; and
use the embeddings for causal discovery to predict additional causal links of the backdoor-adjusted causal knowledge graph.

12. The system of claim 11, wherein to identify backdoor paths comprises:
for a given pair of cause entity and effect entity, identify a set of nodes that satisfy backdoor path criteria, wherein the backdoor path criteria include no node in the set is a child of the cause entity; and
the set blocks every path between the cause entity and the effect entity containing an incoming edge into the cause entity.

13. The system of claim 12, wherein to remove the identified backdoor paths edges that create the identified backdoor paths between the cause entity and the effect entity are removed.

14. The system of claim 11, wherein to convert the backdoor-adjusted causal knowledge graph into embeddings includes using a graph neural network-based approach, where the causal weights are incorporated into the embedding process.

15. The system of claim 11, wherein the one or more hardware computing devices are further configured to perform a Markov-based data split to divide the causal network into training and testing sets before translating the information into the causal knowledge graph.

16. The system of claim 11, wherein the causal discovery includes causal explanation to predict, given an effect entity, a type of a cause entity.

17. The system of claim 11, wherein the causal discovery includes causal prediction to predict, given a cause entity, a type of an effect entity.

18. The system of claim 11, wherein the one or more hardware computing devices are further configured to evaluate the performance of the causal discovery using mean reciprocal rank and Hits@K metrics.

19. A non-transitory computer-readable medium comprising instructions for causal discovery using knowledge graph link prediction that, when executed by one or more computing devices, cause the one or more computing devices to perform operations including:
translate information from a causal network into a causal knowledge graph, the causal knowledge graph comprising a plurality of causal links, wherein each of the causal links includes a cause entity, a causal relation, an effect entity, and a causal weight indicating a relative strength of causal influence of the cause entity on the effect entity;
identify backdoor paths between cause entities and effect entities in the causal knowledge graph; removing the identified backdoor paths from the causal knowledge graph to create a backdoor-adjusted causal knowledge graph;
convert the backdoor-adjusted causal knowledge graph into embeddings, the embeddings comprising a latent vector space representation of the backdoor-adjusted causal knowledge graph;
train the embeddings using the causal links of the backdoor-adjusted causal knowledge graph; and
use the embeddings for causal discovery to predict additional causal links of the backdoor-adjusted causal knowledge graph.

20. The non-transitory computer-readable medium of claim 19, wherein the causal discovery includes one or more of:
causal explanation to predict, given an effect entity, a type of a cause entity; and
causal prediction to predict, given a cause entity, a type of an effect entity.
